(19) United States
(12) Patent Application Publication
(10) Pub. No.: US 2009/0302173 A1
(43) Pub. Date: Dec. 10, 2009

(54) AUTOMATIC FLIGHT CONTROL SYSTEMS

(75) Inventors: Jefferson Michael Hanchey, Woodway, TX (US); Michael Wayne Majors, Waco, TX (US)

Correspondence Address: BANNER & WITCOFF, LTD., 1100 13th STREET, N.W., SUITE 1200, WASHINGTON, DC, 20005-4051, US

(73) Assignee: Science Applications International Corporation, San Diego, CA (US)

(21) Appl. No.: 11/469,701

(22) Filed: Sep. 1, 2006

(51) Int. Cl. B64C 13/00

(52) U.S. Cl. 244/76 A

(57) ABSTRACT

Automatic flight control systems and methods are disclosed. Low duty cycle motors, such as trim actuators may be driven with pulse width modulation signals. The pulse width modulation signals are structured such that the duty cycles of the low duty cycle motors are not exceeded. The low duty cycle motors are attached to and move flight control surfaces to implement automatic flight control commands.

### FIELD OF THE INVENTION

The invention relates to aircraft automatic flight control systems. More particularly, the invention provides methods and systems for implementing an autopilot system by controlling a low duty cycle motor attached to a flight control surface.

### BACKGROUND OF THE INVENTION

Conventional automatic flight control systems or autopilot systems utilize actuators attached to flight control surfaces, such as ailerons, elevator and rudders. FIG. 1 shows an exemplary aircraft having flight control surfaces. Ailerons are used to control movement about a roll axis 100 of the aircraft. Elevators control the movement of the aircraft about its pitch axis 102 and rudders control movement of the aircraft about its yaw axis 104. Some aircraft designs do not incorporate traditional ailerons, elevators and rudders and rely on moving an entire surface, such as a horizontal stabilizer.

Regardless of the type of surface that is used to control movement of an aircraft, conventional autopilot systems control movement of these surfaces with actuators, such as servo motors. These actuators are typically large and many require the installation of hydraulic and electrical lines. High performance aircraft, such as high speed military jets, make efficient use of space and have little or no space available for installing actuators and associated lines. As a result, in many cases it is not possible to install automatic flight control systems on aircraft that were not designed to use automatic flight control systems.

Automatic flight control systems are commonly used to help ensure that aircraft maintain desired flight paths. Maintaining a desired flight path is particularly important when a large number of aircraft occupy the same airspace. In fact, the U.S. Federal Aviation Administration currently requires all aircraft operating within the altitude of 29,000 and 41,000 feet to meet certain autopilot function requirements.

Therefore, there is a need in the art for methods and systems for implementing automatic flight control systems in aircraft that were not designed to include automatic flight control systems and that have limited space available to install conventional automatic flight control system components.

### SUMMARY OF THE INVENTION

One or more of the above-mentioned needs in the art are satisfied by the disclosed automatic flight control systems and methods. In one embodiment an autopilot computer device generates a control signal to control the movement of a low duty cycle motor. The low duty cycle motor is attached to and moves a flight control surface to implement automatic flight control commands. The low duty cycle motor may be an existing trim actuator that was not initially designed to be used to implement an automatic flight control command.

In certain embodiments of the invention, the present invention can be partially or wholly implemented with a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention is illustrated by way of example and not limited in the accompanying figures in which like reference numerals indicate similar elements and in which:

FIG. 1 shows a conventional aircraft having flight control surfaces.

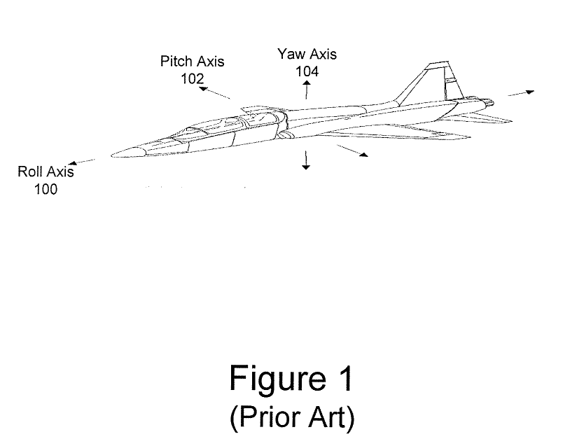

FIG. 2 illustrates an aircraft automatic flight control system, in accordance with an embodiment of the invention.

FIG. 3 illustrates a process for controlling the position of a flight control surface with a motor control signal generated in accordance with an embodiment of the invention.

FIG. 4 illustrates a method of operating an automatic flight control system, in accordance with an embodiment of the invention.

FIG. 5 illustrates a method of retrofitting an aircraft with an automatic flight control system, in accordance with an embodiment of the invention.

### DETAILED DESCRIPTION OF THE INVENTION

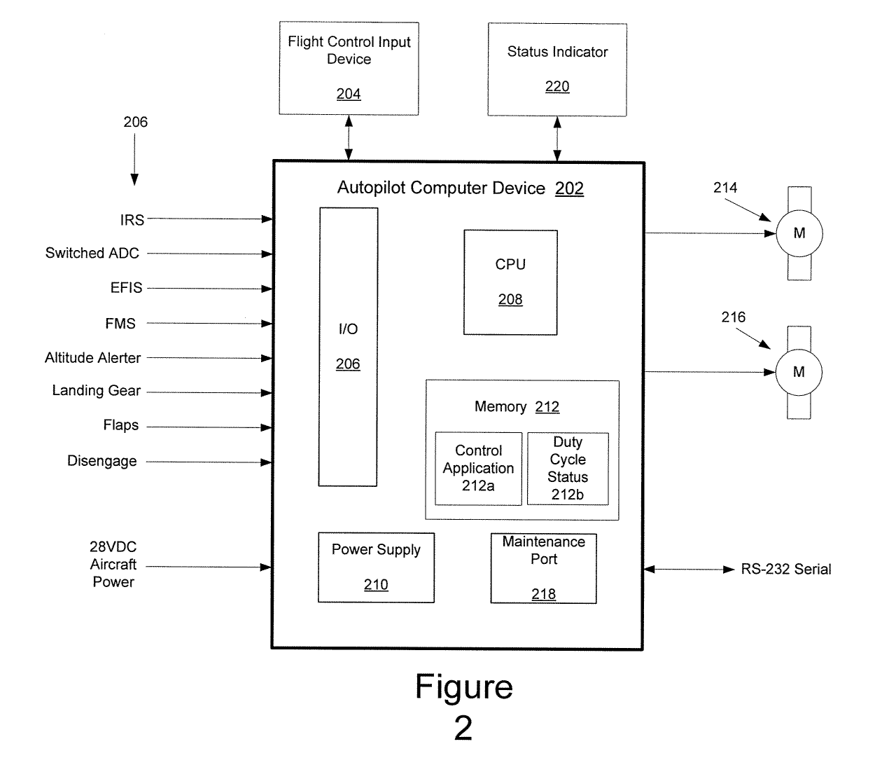

FIG. 2 illustrates an aircraft automatic flight control system in accordance with an embodiment of the invention. An autopilot computer device 202 receives data from a flight control input device 204 and a plurality of aircraft instruments and sensors identified in column 206. Flight control input device 204 may be implemented with a variety of conventional devices used to provide commands to an automatic flight control system. Flight control input device 204 may include input devices for engaging the aircraft automatic flight control system, selecting a desired altitude, selecting a desired heading, maintaining a current altitude, maintaining a current heading and maintaining a current rate of climb.

Autopilot computer device 202 may include an input/output interface 206 that receives data from the sensors and instruments identified in column 206 and provide that data to a central processing unit 208. Central processing unit 208 may be implemented with a conventional processor. A power supply 210 may be included to convert power provided by an aircraft to power utilized by the components included within autopilot computer device 202. A memory 212 maybe coupled to and/or included within central processing unit 208. Memory 212 may be implemented with one or more conventional random access and/or read access memory modules. A control application 212a may be stored within memory 212. As will be described below, control application 212a may be used to process aircraft parameters and generate signals that are used to control one or more low duty cycle motors, such as motors 214 and 216.

Low duty cycle motors 214 and 216 may be implemented with motors that are not conventionally used to implement automatic flight control commands such as altitude hold and heading hold. As used herein a low duty cycle motor is a motor having a duty cycle less than about 15%. In some embodiments of the invention, the systems and method disclosed herein may be used with motors having duty cycles of about 10% and even with motors having duty cycles of about 1.5%. Of course, the aerodynamics of the aircraft, size of the motor and amount of flight control required are factors that will impact the minimal duty cycle required. In one embodiment of the invention, low duty cycle motors 214 and 216 are implemented with trim actuator motors. Motors 214 and 216 may be servo motors, linear motors or other motors that are typically used to control the position of a flight control surface, such as a trim tab. Duty cycle data 212b may also be stored in memory 212. Duty cycle data 212b may include data relating to the past use of a motor and duty cycle limits.

The positions of motors 214 and 216 may be determined using conventional closed-loop circuits. Alternatively, autopilot computer device 202 may estimate the positions of motors 214 and 216. The position may be estimated based on parameters such as, altitude, longitudinal velocity, angle of attack, pitch angle, pitch rate and/or elevator angle.

Autopilot computer device 202 may also include a maintenance port 218 that facilitates performing maintenance functions, such as reprogramming and testing autopilot computer device 202. A status indicator 220 may be coupled to autopilot computer device 202 to alert a pilot that the automatic flight control system will disengage. Status indicator 220 may be in the form of a blinking light or audible signal.

One skilled in the art will appreciate that autopilot computer device 202 may be implemented with a variety of hardware and software components. For example, autopilot computer device 202 may include two or more central processing units, programmable logic arrays, and application-specific integrated circuits (ASICS).

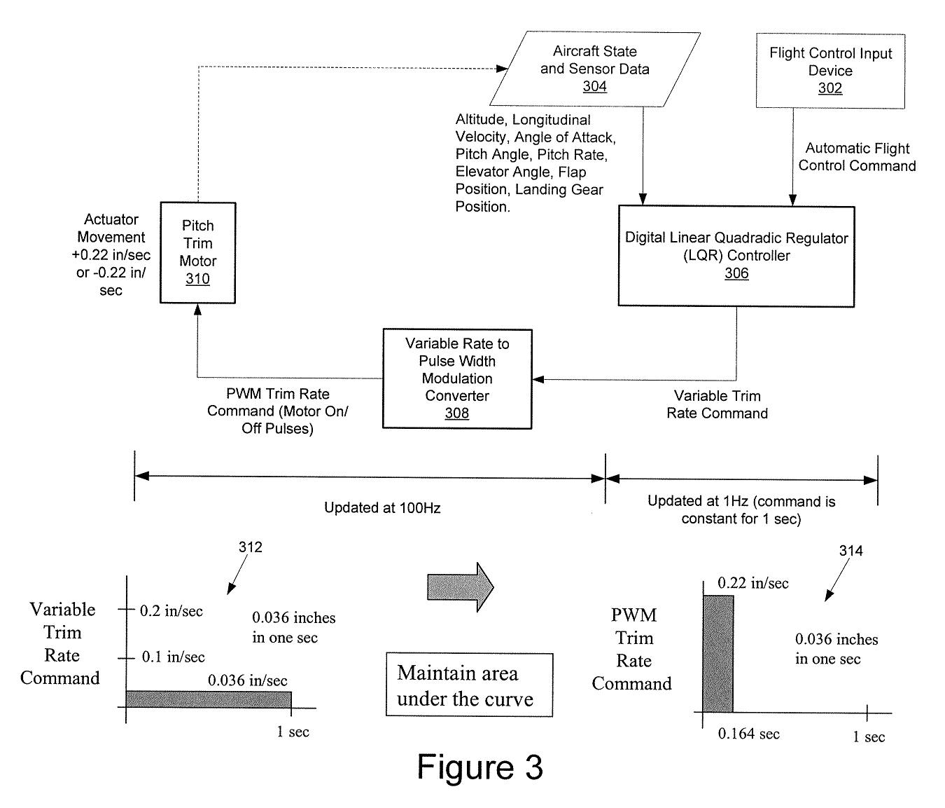

FIG. 3 illustrates a process for controlling the position of a flight control surface with a motor control signal generated in accordance with an embodiment of the invention. A flight control input device 302 may be used to provide automatic flight control commands to a digital linear quadratic regulator (LQR) controller 306. Flight control input device 302 may be similar to flight control input device 204 (shown in FIG. 2). Aircraft state and sensor data 304 is also provided to digital linear quadratic regulator (LQR) controller 306. Aircraft state and sensor data may include:

altitude, longitudinal velocity, angle of attack, pitch angle, pitch rate, elevator angle, flap position and/or landing gear position. Digital linear quadratic regulator (LQR) controller 306 may be implemented with conventional hardware and software components and may be included within autopilot computer device 202 (shown in FIG. 2). One skilled in the art will appreciate that digital linear quadratic regulator (LQR) controller 306 is programmed with a mathematical algorithm that is unique to the type of aircraft that is being controlled.

Digital linear quadratic regulator (LQR) controller 306 processes received aircraft state and sensor data 304 and the automatic flight control command received from flight control input device 302 to generate an error signal configured to implement the automatic flight control command. For example, if the automatic flight control command is an altitude hold command, the generated error signal is configured to return the aircraft to the selected altitude. In the embodiment shown, the error signal is in the form of a variable trim rate command.

The error signal generated by digital linear quadratic regulator (LQR) controller 306 may be transmitted to a variable rate to pulse width modulation converter 308. Variable rate to pulse width modulation converter 308 may be implemented with conventional hardware and software components and may be included within autopilot computer device 202 (shown in FIG. 2). Variable rate to pulse width modulation converter 308 may be configured to generate a pulse width modulation signal that does not exceed the duty cycle of a low duty cycle motor. In the embodiment shown, the trim rate command signal is in the form of a pulse width modulation signal provided to a pitch trim motor 310. Signal 312 is a variable trim rate command signal having a long duration. Variable rate to pulse width modulation converter 308 may be used to shorten the duration and increase the amplitude of this signal to produce a pulse width trim rate command signal 314. The duration of signal 314 may be a function of the duty cycle of pitch trim motor 310. In one embodiment of the invention, digital linear quadratic regulator (LQR) controller 306 and/or variable rate to pulse width modulation converter 308 may be configured to generate a signal to disengage an automatic flight control system or alert the pilot when a pulse width modulation signal, that does not cause the duty cycle of the low duty cycle motor to exceed a duty cycle limit, cannot be produced. This may happen, for example, when an excessive amount of control is required.

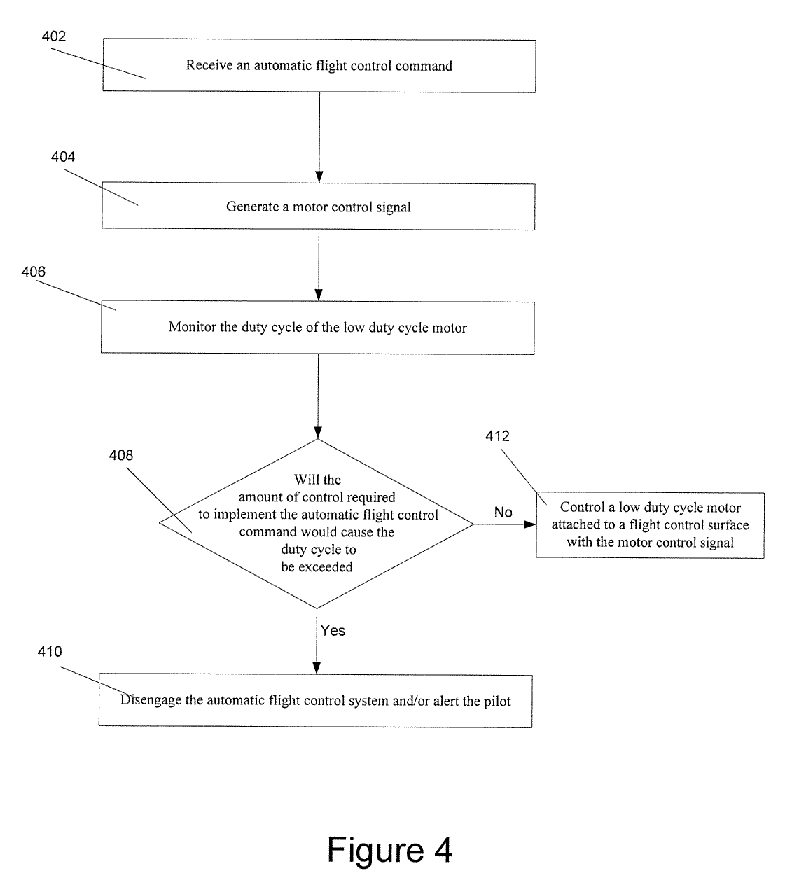

FIG. 4 illustrates a method of operating an automatic flight control system, in accordance with an embodiment of the invention. First, in step 402 an automatic flight control command is received. The command may be provided by a user and may be an altitude hold, heading hold, altitude select, heading select, rate of climb select or other type of automatic flight control command. Next, in step 404 a motor control signal is generated. The motor control signal may be generated with an autopilot computer device, such as autopilot computer device 202 (shown in FIG. 2). The motor control signal may be designed for use with a low duty cycle motor.

Step 404 may include generating a pulse width modulation signal that does not cause the duty cycle of the low duty cycle motor to be exceeded.

The duty cycle of a low duty cycle motor is monitored in step 406. Monitoring may include accumulating data relating to the past use of a motor, such as the use of the motor during a previous predetermined time period. In step 408 it is determined if the amount of control required to implement the automatic flight control command would cause the duty cycle to be exceeded. When the duty cycle would be exceeded, in step 410 the automatic flight control system may be disengaged and/or the pilot may be alerted. The pilot may be alerted by a light, audible sound or some other means. When the automatic flight control system is disengaged, the pilot may be alerted by a light, audible signal or some other means. When the amount of control required would not cause the duty cycle to be exceeded, in step 412 the motor control signal is used to control a low duty cycle motor attached to a flight control surface. Step 412 may include controlling a trim actuator motor.

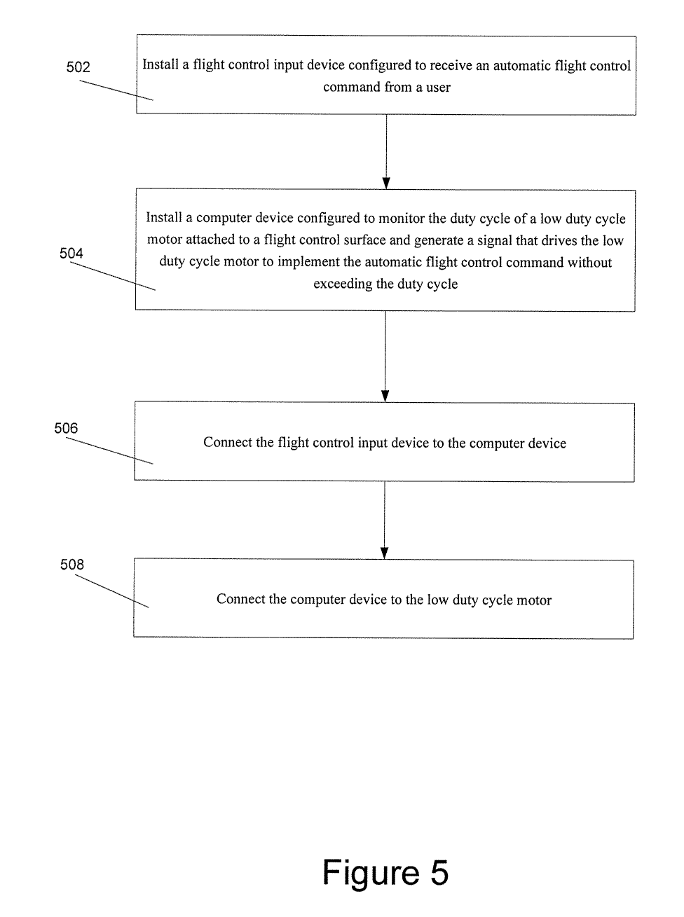

FIG. 5 illustrates a method of retrofitting an aircraft with an automatic flight control system, in accordance with an embodiment of the invention. The method shown in FIG. 5 may be used, for example, with aircraft that have little or no available space available to install conventional automatic flight control system components, such as T-38 and F-5 aircraft.

First, in step 502 a flight control input device that is configured to receive an automatic flight control command from a user is installed. Step 502 may include installing a device in the cockpit that allows a pilot to enter commands such as: altitude hold, altitude select, heading hold, heading select and rate of climb hold. Next, in step 504 a computer device configured to monitor the duty cycle of a low duty cycle motor attached to a flight control surface and generate a signal that drives the low duty cycle motor to implement the automatic flight control command without exceeding the duty cycle is installed. Step 504 may include installing an autopilot computer device similar to autopilot computer device 202 (shown in FIG. 2). Next, in step 506 the flight control input device is connected to the computer device. Finally, the computer device is connected to the low duty cycle motor in step 508.

One skilled in the art will appreciate that the order of steps shown in FIGS. 4 and 5 are exemplary and that the invention is not limited to the orders shown. Alternative embodiments of the invention may include steps arranged in different orders.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, aspects of the disclosed autopilot systems and methods may be used to control vehicles other than aircraft, such as ships.

1. A jet aircraft automatic flight control system comprising:
a flight control input device configured to receive an automatic flight control command from a user;
a low duty cycle motor attached to a flight control surface that controls the altitude of the jet aircraft; and
a computer device configured to monitor the duty cycle of the low duty cycle motor and generate signals that drive the low duty cycle motor to implement the automatic flight control command without exceeding the duty cycle.

2. (canceled)

3. The aircraft automatic flight control system of claim 1, wherein the low duty cycle motor comprises a linear motor.

4. The aircraft automatic flight control system of claim 1, wherein the low duty cycle motor has a duty cycle of less than about 15%.

5. (canceled)

6. The aircraft automatic flight control system of claim 1, wherein the computer device is configured to control the low duty cycle motor to maintain an altitude of an aircraft.

7. (canceled)

8. (canceled)

9. The aircraft automatic flight control system of claim 1, wherein the computer device is configured to control the low duty cycle motor to obtain a desired aircraft altitude.

10. The aircraft automatic flight control system of claim 1, wherein the computer device comprises a digital linear quadratic regulator (LQR) controller.

11. The aircraft automatic flight control system of claim 10, wherein the computer device comprises a variable rate to pulse width modulation converter coupled to the digital linear quadratic regulator controller.

12. The aircraft automatic flight control system of claim 1, wherein the computer device is configured to estimate a position of the low duty cycle motor.

13. The aircraft automatic flight control system of claim 1, wherein the low duty cycle motor comprises a trim actuator motor.

14. (canceled)

15. A method of operating a jet aircraft automatic flight control system, the method comprising:
(a) receiving an automatic flight control command;
(b) in response to (a), generating a motor control signal; and
(c) controlling a low duty cycle motor attached to a flight control surface with the motor control signal, wherein the flight control surface controls the altitude of the jet aircraft.

16. (canceled)

17. The method of claim 15, wherein the low duty cycle motor comprises a linear motor.

18. The method of claim 15, wherein the low duty cycle motor has a duty cycle of less than about 15%.

19. The method of claim 15, wherein the low duty cycle motor comprises a trim actuator motor.

20. The method of claim 15, further including:
(i) monitoring the duty cycle of the low duty cycle motor; and
(ii) alerting a pilot when an amount of control required to implement the automatic flight control command would cause the duty cycle to be exceeded.

21. A method of retrofitting a jet aircraft with an automatic flight control system, the method comprising:
(a) installing a flight control input device configured to receive an automatic flight control command from a user;
(b) installing a computer device configured to monitor the duty cycle of a low duty cycle motor attached to a flight control surface that controls the altitude of the jet aircraft and generate signals that drive the low duty cycle motor to implement the automatic flight control command without exceeding the duty cycle; and
(c) connecting the flight control input device to the computer device; and
(d) connecting the computer device to the low duty cycle motor.

22. The method of claim 21, wherein the low duty cycle motor has a duty cycle of less than about 15%.

23. (canceled)

24. The method of claim 21, wherein the computer device is configured to control the low duty cycle motor to maintain an altitude of an aircraft.

25. The method of claim 21, wherein the low duty cycle motor comprises a trim actuator motor.

26. The method of claim 21, wherein the low duty cycle motor comprises a linear motor.

27. The method of claim 21, wherein the computer device comprises a digital linear quadratic regulator (LQR) controller.

28. The method of claim 21, wherein the computer device comprises a variable rate to pulse width modulation converter coupled to the digital linear quadratic regulator controller.
